(19) United States
(12) Patent Application Publication
(10) Pub. No.: US 2011/0093863 A1
(43) Pub. Date: Apr. 21, 2011

(54) Context switching in a data processing apparatus

(76) Inventors: Jef Louis Verdonck, Berlaar (BE); Mladen Wilder, Cambridge (GB); Johan Matterne, Landen (BE)

(21) Appl. No.: 12/588,621

(22) Filed: Oct. 21, 2009

(51) Int. Cl. G06F 9/48; G06F 13/24

(52) U.S. Cl. 718/108; 710/260

(57) ABSTRACT

A data engine that can be interrupted is disclosed, the data engine comprising plurality of elements for storing, routing and processing the data, the plurality of elements comprising: processing elements for processing the data; registers for storing the data being processed; the data processing engine being configured to receive a clock signal and in response to the clock signal to periodically transmit a plurality of the control signals to a corresponding plurality of the elements in parallel; the data engine further comprising: control circuitry configured in response to receipt of an external interrupt request: to pause transmission of the control signals to the elements and to transmit a copy of the register data stored in the plurality of registers to a store; to transmit in parallel a next plurality of the control signals in the stream of control signals to a corresponding plurality of the elements, and to transmit a copy of output data output by the processing elements in response to the next plurality of control signals to the store and to repeat the transmitting and copying procedure, such that the procedure is performed a number of times. The state of the engine has then been stored and to restore the state the control circuitry requests the stored register data from the store and restores the plurality of registers to store the register data; transmits the next plurality of control signals to the corresponding plurality of elements, and copies the output data received from the store corresponding to data previously output by the processing elements in response to the next plurality of control signals to output locations of the processing elements and repeats the transmitting and copying procedure such that the transmitting and copying procedure is performed the number of times; and then recommences the periodic transmission of the plurality of control signals to the corresponding plurality of the elements in parallel, in response to the clock signal.

### BACKGROUND OF THE INVENTION

1. Field of the Invention

The field of the invention relates to data processing and in illustrative embodiments to interrupting a task in a data processing apparatus to switch to a higher priority task.

2. Description of the Prior Art

Data processing apparatus that perform computer intensive processing tasks often called data engines are known. These tasks are generally initiated by an external host and after a task is finished the data engine will enter an idle state in order to preserve low power. In the idle state it can accept a new task.

In some systems it may be advantageous if the data engine can interrupt a lower priority task to perform a higher priority task. To do this the external host may use pre-emptive scheduling techniques to multiplex the data engine between multiple tasks of different priorities. A traditional way of doing this is to map the tasks onto priority queues and to interrupt a lower priority task when a higher priority task is queued. However, many data engines performing computer intensive tasks have time-stationary pipeline control where multiple instructions are alive at any one time. This makes the interrupt of such an engine difficult as it is difficult to relate the pending control signals back to the instructions they were derived from.

Traditionally interrupts are managed by stopping further instructions entering the processor and waiting until the instructions that are currently being processed complete or retire. At this point one knows that the processor pipeline is empty and the current state of the processor can be saved and the new task started. When the new higher priority task has completed then the saved state can be restored and the interrupted process can be restarted with the instruction that was pending subsequent to the interrupt. This procedure can only be performed where the hardware can determine when instructions have completed. In the case of a processor where the instructions are split into several control signals that are then sent to different elements without any indicator to link them to the instruction they were derived from then the hardware cannot determine when is a good time to halt the processor and save the state. Thus, the conventional way of handling interrupts is not appropriate.

In order to address this, the entire state of the data engine could be saved including the state within the pipelines, this would require much state to be saved, particularly where there are parallel pipelines. In order to be able to save a lot of state shadow registers could be used with dedicated extra routing to access the internal state of the elements. In the case of a register rich architecture with wide registers this solution is extremely costly in area.

Alternatively, co-operative mechanisms whereby the programmer or compiler inserts checkpoints into the code at regular intervals so that the hardware can determine when an instruction is complete could be used. A problem with co-operative mechanisms is that they are software controlled and they periodically check for an interrupt so that they introduce a delay into the interrupt handling mechanism.

It would be desirable to be able to provide priority scheduling of tasks for processors without increasing processing power or area overheads unduly.

### SUMMARY OF THE INVENTION

A first aspect of the present invention provides a data processing apparatus for processing data in response to a stream of control signals, comprising: a plurality of elements for storing, routing and processing said data, said plurality of elements comprising: at least one processing element for processing said data; a plurality of registers for storing said data being processed; said data processing apparatus being configured to receive a clock signal and in response to said clock signal to periodically transmit a plurality of said control signals to a corresponding plurality of said elements in parallel; said data processing apparatus further comprising: control circuitry configured in response to receipt of an external interrupt request: to pause transmission of said control signals to said elements and to transmit a copy of said register data stored in said plurality of registers to a store; to transmit in parallel a next plurality of said control signals in said stream of control signals to a corresponding plurality of said elements, and to transmit a copy of output data output by said at least one processing element in response to said next plurality of control signals to said store and to repeat said transmitting and copying procedure, such that said procedure is performed a number of times; said control circuitry being further configured in response to a control signal to recommence said interrupted processing to: request said stored register data from said store and restore said plurality of registers to store said register data; transmit said next plurality of control signals to said corresponding plurality of elements, and to copy said output data received from said store corresponding to data previously output by said at least one processing element in response to said next plurality of control signals to output locations of said at least one processing element and to repeat said transmitting and copying procedure such that said transmitting and copying procedure is performed said number of times; and to recommence said periodic transmission of said plurality of control signals to said corresponding plurality of said elements in parallel, in response to said clock signal.

The present invention recognises that although it may not be possible to determine exactly when an instruction has completed in a processing apparatus, it may be possible to recreate the state at an interrupt point, by saving the state at the point it was interrupted and then stepping through the next few parallel sets of control signals and saving the changes in state that they provoke. Then when the state of the processor needs to be restored, the state at the point it was interrupted can be input, and the processor can once again step through the next few parallel sets of control signals. As the processor steps through these control signals, the changes in state that these control signals previously provoked and that was saved, can be written to the appropriate output locations. In this way, although the state inside the elements may not be recreated immediately this does not matter, as both the input state and the output state of these elements can be recreated. Thus, the input state feeds through the system until the internal state is the same as it would have been at this point in the processing if the interrupt had not occurred, while the output state is correct as it is the state stored in response to the processor stepping through these control signals immediately after the interrupt.

Thus, one can recreate in a step by step fashion the state of the processor at a certain point after the interrupt was received even when the hardware cannot relate any of the control signals to the instructions they were created from. When the processing apparatus has its state restored, processing can recommence with the subsequent control signals in the control signal stream being sent to the processor for processing in a clocked fashion.

In some embodiments, said number of times is equal to a maximum number of serial processing stages in one of said at least one processing elements.

In order to be able to restore the internal state of a pipeline ready for it to operate in the way it would have operated if the interrupt had not occurred, then the processing apparatus needs to step through enough control signals to fill the pipeline, thus, if it steps through the signals a number of times equal to the maximum number of serial processing stages in any of the processing element on can be sure that the pipeline will have been restored. Thus, although all the state of the system has not been saved, all the relevant state has been saved and the data processing apparatus can be restored following the interrupt by stepping through this number of control signals and saving the stored state at the outputs of the respective processing elements.

It should be noted that if this was performed a number of times that was greater than a maximum number of serial processing stages then the state could be correctly restored but it would take longer than is necessary.

In some embodiments, said store comprises a memory external to said data processing apparatus

Although the data indicating the state of the processing apparatus can be stored in a number of places, it may be advantageous to store it on an external memory as storing it on the data processing apparatus itself would require significant additional storage space within this apparatus.

In some embodiments, said data processing apparatus further comprises said store, said store comprising a first in first out buffer, said data processing apparatus comprising output control circuitry for controlling output of said data from said first in first out buffer to an external memory, such that in response to a control signal from said output control circuitry, data from said first in first out buffer is streamed to said external memory.

The data that is output could be stored within the data processing apparatus in a first-in first-out buffer prior to it being output from the processing apparatus. This would allow it to be streamed via output circuitry to external memory at an appropriate time and this is an efficient way of outputting the data.

In some embodiments, said control signals comprise micro-operands, each micro-operand controlling one of said plurality of elements during a clock cycle of said clock signal.

Although the control signals can take a number of forms in some embodiments they are micro-operands, these are control signals that control individual elements for a clock cycle of the clock signal. The compiler will have generated these micro-operands from the instructions, with each micro-operand controlling a different element within the processing apparatus. Once the micro-operands have been generated, if one does not have knowledge of the compiler one cannot determine from which instructions the micro-operands have been generated. Thus, one cannot relate the micro-operands back to the original instruction stream.

In some embodiments, said data processing apparatus is configured in response to said clock signal to periodically transmit a plurality of said micro-operands corresponding to all of said elements in parallel, said plurality of said micro-operands comprising a very long instruction word.

In some embodiments micro-operands are generated for all of the elements that are controlled by them in the data processing apparatus. Thus for each clock cycle a micro-operand is sent to each and every element. It may be that some of the micro-operands are no operation operands indicating no operation needs to be performed. In other embodiments a plurality of micro-operands are sent to a plurality of elements in parallel but not to all of the elements.

In some embodiments, at least one of said at least one processing element is configured to route data received at an input from at least one of said plurality of registers to an output without passing said data through processing stages within said at least one processing element and to transmit said output data to said store in response to a control signal to output said register data from said control circuitry.

In order to output the state stored in registers in the processing apparatus, in some embodiments a path is provided through the processing element associated with the register that does not pass through the processing stages of that element. Data to be output from the register can then be read by the processing element and passed through it to its output where it can be sent to the store. Paths for transmitting data from registers to processing elements and from processing elements to the memory already exist and thus, data can be output from the apparatus without introducing many additional paths. Each processing element will need to respond to a control signal to route data through this path and thus, extra control circuitry will be required with the element so that this function can be performed. However the overhead associated with this is low.

It should be noted that by using existing paths in this way the data is output in a serial fashion rather than in parallel and thus, it takes longer but requires less circuitry. In processing apparatus with very wide registers the additional area that would be required for parallel paths would be very significant.

In some embodiments, said output data output by said at least one of said at least one processing element in response to one of said plurality of control signals is output to at least one of said registers, and said copying of said output data to said store comprises outputting said data from said at least one of said registers to said input of said at least one of said at least one processing element and passing said data through said at least one processing element to said processing element output without passing through said processing stages.

When operating in the step by step mode whereby control signals are sent in a step wise fashion to processing elements and the updated state that they trigger is then stored, this updated state can be output directly to the store or in some embodiments it may be stored in a register and then the data from this register may be output by passing it through the path in the processing element that avoids the processing stages and is used to output data from the registers when storing the register state, thus, again reusing these paths.

In some embodiments, said data processing apparatus comprises a control signal register for storing said plurality of control signals that have most recently been sent to said corresponding plurality of elements, and said control circuitry is configured to determine from said data in said control signal register which of said plurality of registers has been updated by said most recently sent plurality of control signals and to copy data from said updated registers.

In some embodiments the registers that are updated by the control signals sent in a step by step manner can be determined from data in the control signal register. Thus, in some embodiments the control circuitry determines the registers to be updated by the control signals and then outputs this updated data to the store.

In some embodiments, said data transmitted to said store in response to said external interrupt requests further comprise data stored in at least one program counter.

In addition to the data stored in the registers, the data stored in a program counter may also be required when saving state as this allows the processing apparatus to know at what point in the control signal stream i the interrupt was received at and thus, from where processing should recommence.

In some embodiments, said transmission of said data to said store is performed as a plurality of sequential serial steps, such that data is output as a serial data stream.

Owing to the re-use of data paths the transmission of the data to the store is performed as a plurality of sequential serial steps which although slow avoids the need to introduce additional parallel paths.

In some embodiments, said external interrupt request signal indicates a higher priority task to be performed, and said data processing apparatus is configured to commence processing of said higher priority task in response to detection that said transmitting and copying procedure has been performed said number of times; and said control circuitry is configured in response to detecting completion of said higher priority task, to generate said control signal to initiate recommencing of said interrupted processing.

The external interrupt request signal may be used to indicate a higher priority task that needs to be performed. In such a case, following downloading of the relevant state the higher priority task is performed and the control circuitry is configured to detect completion of this task and to generate the control signal that initiates recommencing of the interrupted processing.

In some embodiments, said control circuitry is configured to overwrite data items written to said output locations in response to said next plurality of control signals with said output data received from said store that was generated in response to a same next plurality of control signals.

When restoring the data, the control signals are sent in a step by step fashion and the output locations of the processing elements are written to with the data that was stored and was output when these control signals were executed immediately following the interrupt. When this data is written to these output locations it may overwrite the data that the processing element has output and which should not be stored as it is based on data that was in the pipeline at the start of the process recommencing and is in effect dummy data as it does not relate to the previous steps in this processing cycle, or the pipeline could be inhibited from outputting any data during this step by step operation and the data retrieved from the store could simply be written to the location indicated.

In some embodiments, said output locations comprise at least some of said plurality of registers.

In some embodiments, said data processing apparatus comprises a control signal register for storing said plurality of control signals that has been most recently sent to said corresponding plurality of elements, and said control circuitry is configured to determine from said data in said control signal register which of said plurality of registers to overwrite with data from retrieved from said store.

In order to determine the output locations to overwrite with the stored data the values stored in the control signal register can be used to determine which registers are updated by the most recently sent control signals.

In some embodiments, each of said at least one processing elements comprises a plurality of parallel pipelines each of said pipelines comprising at least two processing stages arranged in series, one of said plurality of control signals received at said at least one processing element being routed to one of said plurality of pipelines.

The processing elements may comprise a number of parallel pipelines consisting of several stages each. In such a case, the step by step retrieval of data from the active pipeline is an efficient way of retrieving the relevant state and storing this and avoids the need to download all state present throughout the parallel pipelines of the processing apparatus.

A second aspect of the present invention provides a method of interrupting a task to be executed by a data processing apparatus, said data processing apparatus processing data in response to a stream of control signals, and said data processing apparatus comprising: a plurality of elements for storing, routing and processing said data, said plurality of elements comprising: at least one processing element for processing said data; a plurality of registers for storing said data being processed; said method comprising the steps of: periodically transmitting a plurality of said control signals to a corresponding plurality of said elements in parallel in response to a clock signal; receiving an external interrupt request indicating a higher priority task to be performed: pausing transmission of said control signals and transmitting a copy of register data stored in said plurality of registers to a store; transmitting a next plurality of said control signals in said stream of control signals to a corresponding plurality of elements in parallel; transmitting a copy of output data output by said at least one processing element in response to said next plurality of control signals to said store; and repeating said preceding two transmitting steps such that they are performed a number of times; and in response to a control signal to recommence said interrupted processing: requesting said stored register data from said store and restoring said plurality of registers to store said register data; transmitting said next plurality of control signals to said corresponding plurality of elements, and copying said output data received from said store corresponding to data previously output by said at least one processing element in response to said next plurality of control signals to output locations of said at least one processing element; and repeating said transmitting and copying step such that said transmitting and copying step is performed said number of times; and recommencing said periodic transmission of said plurality of control signals to said corresponding plurality of said elements in parallel in response to said clock signal.

A third aspect of the present invention provides a means for processing data in response to a stream of control signals, comprising: a plurality of means for storing, routing and processing said data, said plurality of means comprising: a plurality of processing means for processing said data; a plurality of register means for storing said data being processed; said data processing apparatus being configured to receive a clock signal and in response to said clock signal to periodically transmit in parallel a plurality of said control signals to a corresponding plurality of said means; said means for processing data further comprising: control means for pausing transmission of said control signals to said means and for transmitting a copy of said register data stored in said plurality of register means to a store in response to receipt of an external interrupt request; and for transmitting in parallel a next plurality of said control signals in said stream of control signals to a corresponding plurality of said means, and for transmitting a copy of output data output by said processing means in response to said next plurality of control signals to said store and for repeating said transmitting and copying procedure, such that said procedure is performed a number of times; said control means being for recommencing said interrupted processing in response to a control signal by: requesting said stored register data from said store and restoring said plurality of register means to store said register data; transmitting said next plurality of control signals to said corresponding plurality of means, and copying said output data received from said store corresponding to data previously output by said processing means in response to said next plurality of control signals to output locations of said plurality of processing means and repeating said transmitting and copying procedure such that said transmitting and copying procedure is performed said number of times; and recommencing said periodic transmission of said plurality of control signals to said corresponding plurality of said means in parallel, in response to said clock signal.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 shows a portion of the data processing apparatus according to an embodiment of the present invention;

FIG. 2 schematically shows the very long instruction words being sent to a processing element of the apparatus;

FIG. 3 shows the data processing apparatus according to an embodiment of the present invention and associated circuitry;

FIG. 4 shows a flow diagram illustrating steps in a method of interrupting a data engine; and

FIG. 5 shows a flow diagram illustrating steps in a method of restoring the state of a data engine.

### DESCRIPTION OF THE PREFERRED EMBODIMENTS

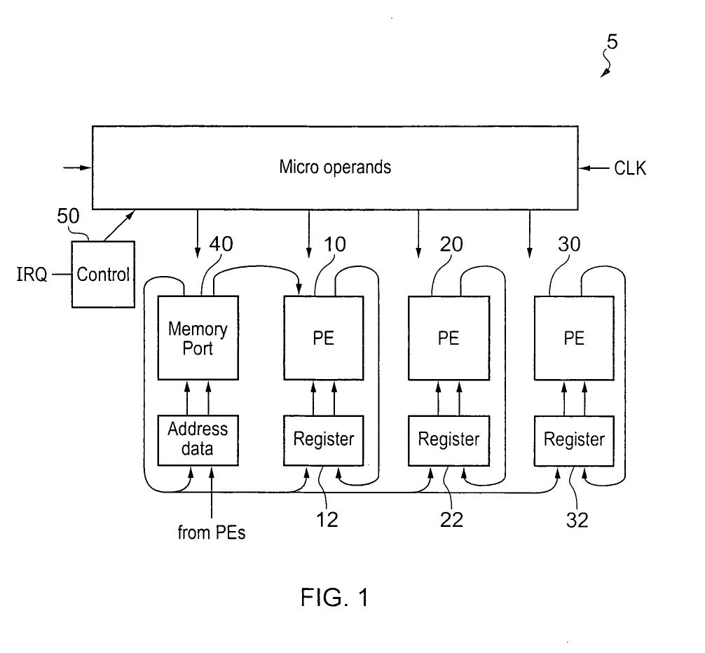

FIG. 1 shows a portion of a data processing apparatus 5 that receives a plurality of micro-operands in parallel in the form of a very long instruction word (VLIW) in a clocked fashion. Thus, for every clock cycle micro-operands are sent in parallel to all the elements within a data processing apparatus 5. These elements include processing elements PE that process data in response to the micro-operands, register files for storing the data that the processing elements are processing and other elements not shown such as routing elements that route the data to the required storage or processing element. These include such things as multiplexers.

Processing elements 10, 20, 30 each have register files 12, 22 and 32 associated with them. These register files store the data that the processing elements process and thus, the processing elements will read data from the register file, process it and output the data. This output data may then be stored back to the register file or it may be output directly to memory port 40. Memory port 40 can output data it receives from elements within the processing apparatus 5 to an external memory and it can receive data from an external memory and forward it to the register files within processing apparatus 5.

Data processing apparatus 5 also has control circuitry 50 that is responsive to external interrupt request IRQ to control the processing apparatus to halt processing, store current state to memory and perform a new higher priority task. Control circuitry 50 also controls the restoring of the state of the processor so that it can recommence processing the interrupted task.

Although the control circuitry 50 is shown as a block of circuitry in FIG. 1, this is purely schematic and as will understood by a skilled person this control circuitry may be formed of such a block or it may be distributed throughout the data processing apparatus having portions next to the elements that are controlled by it.

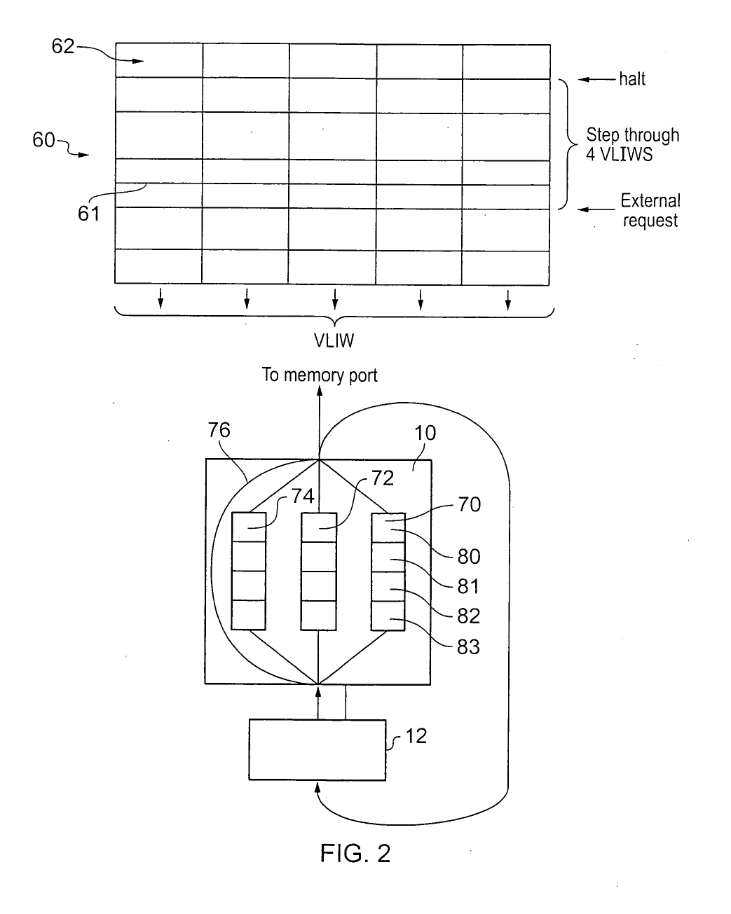

In response to receipt of the interrupt signal IRQ, control circuitry 50 will halt the sending of the next parallel set of micro-operands and when the current ones have completed processing at the end of the clock cycle it will store the current values stored in the registers to memory. It will then step through the next few sets of micro-operands and will output the data output from each processing element to memory. This will be described with respect to FIG. 2.

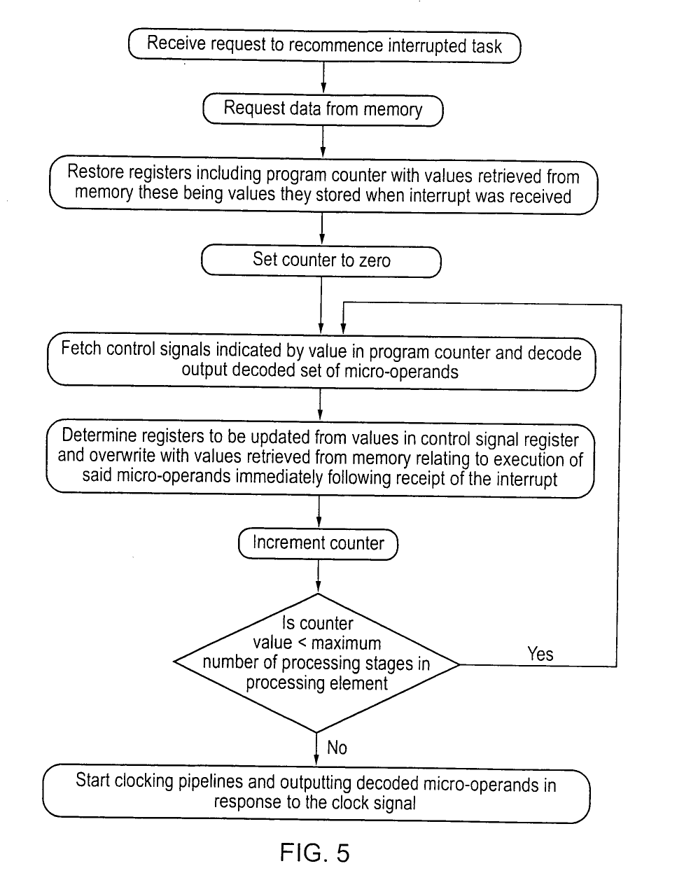

FIG. 2 shows schematically the micro-operands in the form of VLIWs in a program stream 60. Micro-operands from each VLIW are passed on each clock cycle to the processing apparatus 5. FIG. 5 also shows a single one of the processing elements 10 and illustrates that inside this processing element 10 there are parallel pipelines 70, 72 and 74 each having multiple processing stages. One of the micro-operands in each VLIW will be sent to processing element 10, and will be routed to one of the pipelines 70, 72 or 74.

There is also a path 76 which goes directly from the input of the processing element 10 to its output without going through the processing stages and this path is used to output data from the register files to the memory port. By including this data path within the processing element data can be output from the registers using this path and other paths that already exist within the apparatus.

Thus, in response to the interrupt request being received at control circuitry 50, control circuitry 50 sends a command to processing element 10 to read the data in the register file 12 and to send it via path 76 to the memory port. This is done in a serial fashion as there are no additional parallel paths added and thus, the data is output sequentially from register file 12 via processing element 10 to the memory port.

Once the data from the registers within data processing apparatus 5 have been output to memory then the control circuitry 50 sends the next VLIW 61 in the program stream to the elements within data processing apparatus 5. These cause the processing elements to perform further processing and the data output from each processing element is then sent to memory port 40 for output to the memory.

This is performed four times in this case which reflects the maximum number of processing stages in any of the pipelines within the different processing elements. These are shown in processing element 10 in this figure as 80, 81, 82 and 83. By performing these four steps and sending four sets of micro-operands to processing apparatus 5 one can be sure that all the state within the active pipeline that was present when the interrupt was received has been output. In effect this is a compaction of data as rather than outputting all the state within all of the processing elements one simply steps out the state that is required by the next few micro-operands and thus, the active state of the pipeline is output and this is the important state that is required to restore the state of the data processing apparatus 5. In this respect there are multiple parallel paths within the elements and thus, multiple parallel states, however only one of these is actually valid every cycle as only one result per element can be output every cycle.

Thus, one can see that the number of VLIW's that are output following an external request is equal to the maximum number of processing stages within any of the processing elements.

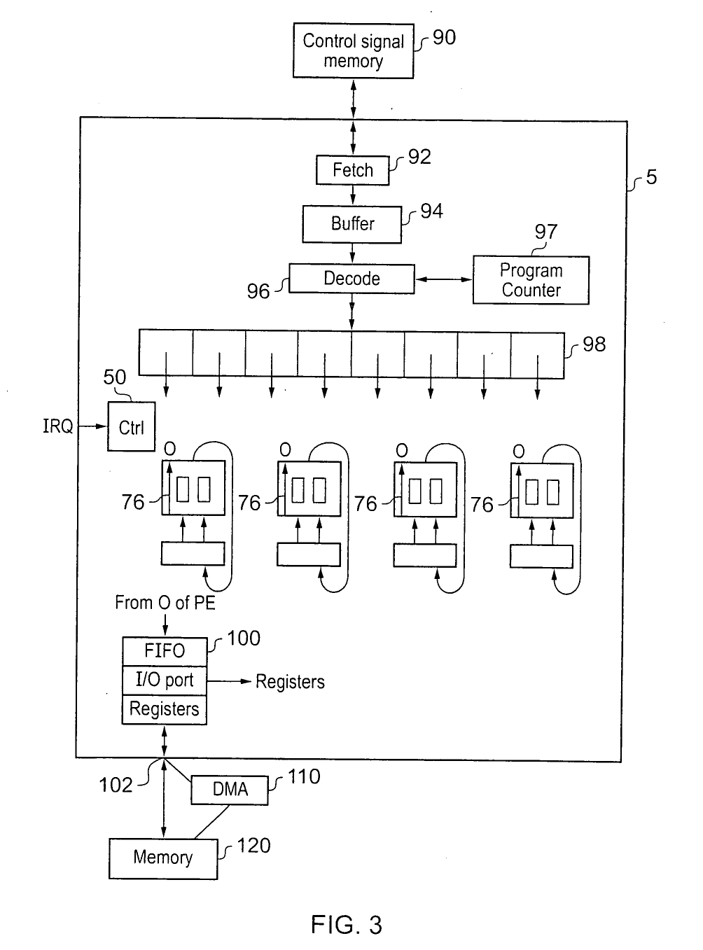

FIG. 3 shows a data processing system including the data processing apparatus 5 of an embodiment of the present invention.

This shows in more detail how compiled instructions from control signal memory 90 are fetched by data processing apparatus by using control signal fetch circuitry 92, are buffered within buffer 94, and are then decoded by decode circuitry 96. They are then stored in a control signal register 98. Control signal register 98 stores a plurality of micro-operands, each one controlling a different element within data processing apparatus 5. Compacted compiled instructions are stored within control signal memory 90 and these are decoded by decoder 96 which generates VLIWs with control signals for each element within processing apparatus 5, these control signals are stored as the VLIW in control signal register 98. It may be that during a particular clock cycle not every element needs to perform a function and thus, the VLIW may have several micro-operands which indicate no operation to the element they control. This is because all elements have a micro-operand within the very long instruction word that pertains to them and all elements within data processing apparatus 5 are sent a micro-operand even if it might be a no operation on each clock cycle.

In order to output the current state of the processing apparatus, control circuitry controls the processing elements to read their register files and to pass the data using the path 76 bypassing the processing stages to output O which then passes it to memory port 100. In this embodiment, memory port 100 has a FIFO buffer that is a first in first out data store so that this output data is stored in this buffer until a request is received from a DMA 110 at which point the data is streamed out of output port 102 to memory 120 where it is stored.

When the data from the register files has been output control circuitry 50 controls decode 96 to receive the next set of micro-operands from buffer 94 and to form the next VLIW for input to control signal register 98. The micro-operands within this VLIW are then sent to the various elements within data processing apparatus 5. Control circuitry 50 then determines which registers are updated in this clock cycle and it controls the processing elements to read data from the updated registers and to output this data via paths 76 in each processing element to memory port 100 where they are again stored in the FIFO buffer until an instruction is received from DMA 110 to stream them to memory. When determining which registers are to be updated the control circuitry may look at micro-operands from the control signal register.

It should be noted that although in this embodiment the data output by the processing element is first stored in the registers and is then output to memory port 100, in some embodiments it might be output directly from the processing element to the memory port. This would clearly save some storage power but might require more complex control circuitry.

Once the control circuitry 50 has controlled decode circuitry 96 to step through the number of VLIW's corresponding to the maximum number of processing stages within a new processing element, sufficient state has been stored to memory to enable it to be restored and thus, the processor can be reset ready to start the new higher priority task. It should be noted that there is a program counter 97 which indicates which control signal is currently being decoded and its value at the point the interrupt request was received should also be output to memory so that the processing apparatus can know at which point in the program stream the processing should be recommenced. It should be recommenced at the control signal following the one when the interrupt was received.

When all of the required state has been output, the processing apparatus 5 can be reset and the higher priority task can commence.

When the higher priority task has completed, this completion is detected by control circuitry 50 which then initiates recommencing of the interrupted task.

Initially control circuitry 50 instructs input/output port 100 to receive the data stored to memory in response to the interrupt request received initially before the step by step processing of the micro-operands was performed. Thus, the registers in the register files are restored to restore the value they stored when the interrupt request was received and program counter 97 is restored to the value that it had then. Fetch circuitry 92 then fetches from control signal memory 90, the compiled instruction indicated by program counter 97 and the subsequent compiled instructions and these are stored in buffer 94 and decoded by decode 96. Control signal memory stores compacted code from an external compiler which consists of control signals for controlling the various elements within the data engine 5 during a particular clock cycle.

Thus, in response to the value stored in program counter 97, the control signals in the form of a VLIW relating to the subsequent control signals to be executed following the interrupt are stored in control signal register 98 and these are then sent to their respective elements in response to a signal control circuitry 50. Control circuitry 50 determines from the values stored in the control signal register which registers are to be updated by execution of these micro-operands and it retrieves the data stored to memory relating to the values stored in these registers when these corresponding micro-operands were performed immediately subsequent to the external interrupt request being received and these retrieved values are stored in the appropriate registers. In this way, the data engine 5 steps through a number of control signals subsequent to the interrupt request being received and the output values that the various processing elements generated in response to these micro-operands are again stored in the appropriate registers. Once this has been performed a number of times, the number of times being equal to the maximum number of processing stages within any of the processing elements then the state of the data engine is restored to the state that it had when the interrupt was received and processing can re-commence with the very long instruction word shown as 62 in FIG. 2.

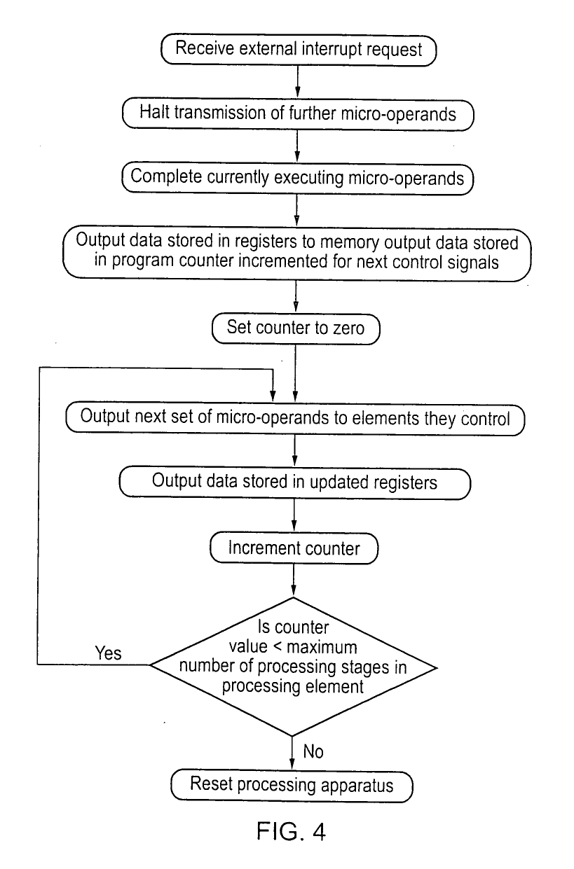

FIG. 4 shows a flow diagram illustrating steps in the method of saving the required state to this data store in response to an external interrupt request being received.

At this point the currently executing program step is finished and transmission of subsequent micro-operands is halted. The current state of the data processing apparatus in this embodiment, a data engine, is then saved. In this case the data stored in the registers including the program counter incremented by one to indicate the next VLIW is output to memory.

A counter is then set to zero and the next set of micro-operands is output to the elements that they control. Data stored in any updated registers is then output to memory and the counter incremented. It is then determined if the counter value is less than the maximum number of processing stages in any of the processing elements. If it is then the steps are repeated ad the next set of operands is output to the elements they control and data in any updated registers is output and the counter is incremented again.

Once again it is determined if the counter value is less than the maximum number of processing stages. If it is not then the processing apparatus is reset ready to commence processing of the higher priority task.

FIG. 5 is a flow diagram showing method steps performed when restoring the state of the data engine such that the interrupted processing task can be recommenced.

Initially a request to recommence the interrupted task is received, this may be generated by control circuitry in response to detecting completion of the higher priority task. In response to this, data from memory is streamed into the engine, in some embodiments into a FIFO from where it is sent to the registers distributed throughout the data engine. In this way the data stored in them is restored to the values that they stored when the interrupt was received. The program counter is also restored and the control signal subsequent to that executing when the interrupt was received in the program stream is fetched from memory.

The counter is then reset and the control signal fetched is decoded and the micro-operands generated are sent to the elements that they control. It is determined from the values in the control signals which registers are updated by these micro-operands and these registers are overwritten with values received from memory. The counter is incremented and it is then determined if the counter value is less than the number of processing stages in a processing element. If it is then the steps are repeated. If it is not the state of the data engine has been restored and the processing recommences with the clock being restarted to clock the pipelines within the processing elements and decode and fetch units are clocked in response to this.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims. For example, various combinations of the features of the following dependent claims could be made with the features of the independent claims without departing from the scope of the present invention.

We claim:

1. A data processing apparatus for processing data in response to a stream of control signals, comprising:
a plurality of elements for storing, routing and processing said data, said plurality of elements comprising:
at least one processing element for processing said data;
a plurality of registers for storing said data being processed;
said data processing apparatus being configured to receive a clock signal and to in response to said clock signal to periodically transmit a plurality of said control signals to a corresponding plurality of said elements in parallel;
said data processing apparatus further comprising:
control circuitry configured in response to receipt of an external interrupt request:
to pause transmission of said control signals to said elements and to transmit a copy of said register data stored in said plurality of registers to a store;
to transmit in parallel a next plurality of said control signals in said stream of control signals to a corresponding plurality of said elements, and to transmit a copy of output data output by said at least one processing element in response to said next plurality of control signals to said store and to repeat said transmitting and copying procedure, such that said procedure is performed a number of times;
said control circuitry being further configured in response to a control signal to recommence said interrupted processing to:
request said stored register data from said store and restore said plurality of registers to store said register data;
transmit said next plurality of control signals to said corresponding plurality of elements, and to copy said output data received from said store corresponding to data previously output by said at least one processing element in response to said next plurality of control signals to output locations of said at least one processing element and to repeat said transmitting and copying procedure such that said transmitting and copying procedure is performed said number of times; and
to recommence said periodic transmission of said plurality of control signals to said corresponding plurality of said elements in parallel, in response to said clock signal.

2. A data processing apparatus according to claim 1, wherein said number of times is equal to a maximum number of serial processing stages in one of said at least one processing elements.

3. A data processing apparatus according to claim 1, wherein said store comprises a memory external to said data processing apparatus

4. A data processing apparatus according to claim 1, said data processing apparatus further comprising said store, said store comprising a first in first out buffer, said data processing apparatus comprising output control circuitry for controlling output of said data from said first in first out buffer to an external memory, such that in response to a control signal from said output control circuitry, data from said first in first out buffer is streamed to said external memory.

5. A data processing apparatus according to claim 1, wherein said control signals comprise micro-operands, each micro-operand controlling one of said plurality of elements during a clock cycle of said clock signal.

6. A data processing apparatus according to claim 5, wherein said data processing apparatus is configured in response to said clock signal to periodically transmit a plurality of said micro-operands corresponding to all of said elements in parallel, said plurality of said micro-operands comprising a very long instruction word.

7. A data processing apparatus according to claim 1, wherein at least one of said at least one processing element is configured to route data received at an input from at least one of said plurality of registers to an output without passing said data through processing stages within said at least one processing element and to transmit said output data to said store in response to a control signal to output said register data from said control circuitry.

8. A data processing apparatus according to claim 7, wherein said output data output by said at least one of said at least one processing element in response to one of said plurality of control signals is output to at least one of said registers, and said copying of said output data to said store comprises outputting said data from said at least one of said registers to said input of said at least one of said at least one processing element and passing said data through said at least one processing element to said processing element output without passing through said processing stages.

9. A data processing apparatus according to claim 8, said data processing apparatus comprising a control signal register for storing said plurality of control signals that has been most recently sent to said corresponding plurality of elements, and said control circuitry is configured to determine from said data in said control signal register which of said plurality of registers has been updated by said most recently sent plurality of control signals and to copy data from said updated registers.

10. A data processing apparatus according to claim 1, said data transmitted to said store in response to said external interrupt request further comprising data stored in at least one program counter.

11. A data processing apparatus according to claim 1, wherein said transmission of said data to said store is performed as a plurality of sequential serial steps, such that data is output as a serial data stream.

12. A data processing apparatus according to claim 1, wherein said external interrupt request signal indicates a higher priority task to be performed, and said data processing apparatus is configured to commence processing said higher priority task in response to detection that said transmitting and copying procedure has been performed said number of times; and
said control circuitry is configured in response to detecting completion of said higher priority task, to generate said control signal to initiate recommencing of said interrupted processing.

13. A data processing apparatus according to claim 1, wherein said control circuitry is configured to overwrite data items written to said output locations in response to said next plurality of control signals with said output data received from said store that was generated in response to a same next plurality of control signals.

14. A data processing apparatus according to claim 1, wherein said output locations comprise at least some of said plurality of registers.

15. A data processing apparatus according to claim 14, said data processing apparatus comprising a control signal register for storing said plurality of control signals that has been most recently sent to said corresponding plurality of elements, and said control circuitry being configured to determine from said data in said control signal register which of said plurality of registers to overwrite with data from retrieved from said store.

16. A data processing apparatus according to claim 1, wherein each of said at least one processing elements comprises a plurality of parallel pipelines each of said pipelines comprising at least two processing stages arranged in series, one of said plurality of control signals received at said at least one processing element being routed to one of said plurality of pipelines.

17. A method of interrupting a task to be executed by a data processing apparatus, said data processing apparatus processing data in response to a stream of control signals, and said data processing apparatus comprising:
a plurality of elements for storing, routing and processing said data, said plurality of elements comprising:
at least one processing element for processing said data;
a plurality of registers for storing said data being processed;
said method comprising the steps of:
periodically transmitting a plurality of said control signals to a corresponding plurality of said elements in parallel in response to a clock signal;
receiving an external interrupt request indicating a higher priority task to be performed:
pausing transmission of said control signals and transmitting a copy of register data stored in said plurality of registers to a store;
transmitting a next plurality of said control signals in said stream of control signals to a corresponding plurality of elements in parallel;
transmitting a copy of output data output by said at least one processing element in response to said next plurality of control signals to said store; and
repeating said preceding two transmitting steps such that they are performed a number of times; and
in response to a control signal to recommence said interrupted processing:
requesting said stored register data from said store and restoring said plurality of registers to store said register data;
transmitting said next plurality of control signals to said corresponding plurality of elements, and copying said output data received from said store corresponding to data previously output by said at least one processing element in response to said next plurality of control signals to output locations of said at least one processing element; and
repeating said transmitting and copying step such that said transmitting and copying step is performed said number of times; and
recommencing said periodic transmission of said plurality of control signals to said corresponding plurality of said elements in parallel in response to said clock signal.

18. A method according to claim 17, wherein said number of times is equal to a maximum number of serial processing stages in one of said at least one processing elements, and following performing said two transmitting steps said number of times, resetting said processor and commencing processing of a higher priority task indicated by said received external interrupt request, and on detection of completion of said higher priority task generating said control signal to recommence said interrupted processing.

19. A method according to claim 18, wherein said step of transmitting a copy of register data stored in said plurality of registers to a store comprises outputting said data from said plurality of said registers to an input of a corresponding processing element and passing said data through said corresponding processing element to said processing element output without passing through any processing stages of said processing element.

20. A method according to claim 19, wherein said data processing apparatus comprising a control signal register for storing said plurality of control signals that has been most recently sent to said corresponding plurality of elements, and said control circuitry is configured to determine from said data in said control signal register which of said plurality of registers has been updated by said most recently sent plurality of control signals and to copy data from said updated registers.

21. A means for processing data in response to a stream of control signals, comprising:
a plurality of means for storing, routing and processing said data, said plurality of means comprising:
a plurality of processing means for processing said data;
a plurality of register means for storing said data being processed;
said data processing apparatus being configured to receive a clock signal and in response to said clock signal to periodically transmit in parallel a plurality of said control signals to a corresponding plurality of said means;
said means for processing data further comprising:
control means for pausing transmission of said control signals to said means and for transmitting a copy of said register data stored in said plurality of register means to a store in response to receipt of an external interrupt request; and
for transmitting in parallel a next plurality of said control signals in said stream of control signals to a corresponding plurality of said means, and for transmitting a copy of output data output by said processing means in response to said next plurality of control signals to said store and for repeating said transmitting and copying procedure, such that said procedure is performed a number of times;
said control means being for recommencing said interrupted processing in response to a control signal by:
requesting said stored register data from said store and restoring said plurality of register means to store said register data;
transmitting said next plurality of control signals to said corresponding plurality of means, and copying said output data received from said store corresponding to data previously output by said processing means in response to said next plurality of control signals to output locations of said plurality of processing means and repeating said transmitting and copying procedure such that said transmitting and copying procedure is performed said number of times; and
recommencing said periodic transmission of said plurality of control signals to said corresponding plurality of said means in parallel, in response to said clock signal.
